(19) United States
(12) Patent Application Publication
(10) Pub. No.: US 2008/0117968 A1
(43) Pub. Date: May 22, 2008

(54) MOVEMENT DETECTION AND CONSTRUCTION OF AN "ACTUAL REALITY" IMAGE

(75) Inventor: Kang-Huai Wang, Saratoga, CA (US)

Correspondence Address: MACPHERSON KWOK CHEN & HEID LLP, 2033 GATEWAY PLACE, SUITE 400, SAN JOSE, CA, 95110, US

(73) Assignee: Capso Vision, Inc.

(21) Appl. No.: 11/866,368

(22) Filed: Oct. 2, 2007

Related U.S. Application Data
(63) Continuation-in-part of application No. 11/562,926, filed on Nov. 22, 2006.

(51) Int. Cl. H04N 7/12

(52) U.S. Cl. 375/240.12; 375/E07.03

(57) ABSTRACT

A method for intraframe image compression of an image is combined with a method for reducing memory requirements for an interframe image compression. The intraframe image compression includes (a) dividing the image into blocks; (b) selecting a block according to a predetermined sequence; and (c) processing each selected block by: (1) identifying a reference block from previously processed blocks in the image according to an activity metric; and (2) using the reference block, compressing the selected block. The selected block may be compressed by compressing a difference between the selected block and the reference block, where the difference may be offset by a predetermined value. The difference is compressed after determining that an activity metric of the difference block. The activity metric depends on elements of a difference block, which is a block in which elements are each a difference between an element of the current image frame and a corresponding element of the reference frame. The activity metric is a function of the sum of (a) the sum over all rows of all differences between two successive consecutive elements of each row of the difference block; and (b) the sum over all columns of all differences between two consecutive elements of each column of the difference block. The reference block is identified by minimizing a cost function based on the activity metric and either a sum of absolute differences function or a sum of square differences function. The cost function may be a weighted sum of the activity metric and either a sum of absolute differences function or a sum of square differences function, or a weighted sum of the activity function and either a sum of absolute differences function or a sum of square differences function.

### CROSS-REFERENCES TO RELATED APPLICATIONS

The present application is a continuation-in-part application of U.S. patent application (“Copending application”), entitled “Movement Detection AND Construction of an ‘Actual Reality’ Image” Ser. No. 11/562,926 and filed on Nov. 22, 2006. The Copending applications is hereby incorporated by reference in their entirety.

### BACKGROUND OF THE INVENTION

1. Field of the Invention

The present invention relates to swallowable capsule cameras for imaging of the gastro-intestinal (GI) tract. In particular, the present invention relates to data compression methods that are suitable for capsule camera applications.

2. Discussion of the Related Art

Devices for imaging body cavities or passages in vivo are known in the art and include endoscopes and autonomous encapsulated cameras. Endoscopes are flexible or rigid tubes that are passed into the body through an orifice or surgical opening, typically into the esophagus via the mouth or into the colon via the rectum. An image is taken at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Endoscopes allow a physician control over the field of view and are well-accepted diagnostic tools. However, they have a number of limitations, present risks to the patient, are invasive and uncomfortable for the patient. The cost of these procedures restricts their application as routine health-screening tools.

Because of the difficulty traversing a convoluted passage, endoscopes cannot reach the majority of the small intestine and special techniques and precautions, that add cost, are required to reach the entirety of the colon. Endoscopic risks include the possible perforation of the bodily organs traversed and complications arising from anesthesia. Moreover, a trade-off must be made between patient pain during the procedure and the health risks and post-procedural down time associated with anesthesia. Endoscopies are necessarily inpatient services that involve a significant amount of time from clinicians and thus are costly.

An alternative in vivo image sensor that addresses many of these problems is capsule endoscopy. A camera is housed in a swallowable capsule, along with a radio transmitter for transmitting data, primarily comprising images recorded by the digital camera, to a base-station receiver or transceiver and data recorder outside the body. The capsule may also include a radio receiver for receiving instructions or other data from a base-station transmitter. Instead of radio-frequency transmission, lower-frequency electromagnetic signals may be used. Power may be supplied inductively from an external inductor to an internal inductor within the capsule or from a battery within the capsule.

An early example of a camera in a swallowable capsule is described in the U.S. Pat. No. 5,604,531, issued to the Ministry of Defense, State of Israel. A number of patents assigned to Given Imaging describe more details of such a system, using a transmitter to send the camera images to an external receiver. Examples are U.S. Pat. Nos. 6,709,387 and 6,428,469. There are also a number of patents to the Olympus Corporation describing a similar technology. For example, U.S. Pat. No. 4,278,077 shows a capsule with a camera for the stomach, which includes film in the camera. U.S. Pat. No. 6,939,292 shows a capsule with a memory and a transmitter.

An advantage of an autonomous encapsulated camera with an internal battery is that the measurements may be made with the patient ambulatory, out of the hospital, and with only moderate restrictions of activity. The base station includes an antenna array surrounding the bodily region of interest and this array can be temporarily affixed to the skin or incorporated into a wearable vest. A data recorder is attached to a belt and includes a battery power supply and a data storage medium for saving recorded images and other data for subsequent uploading onto a diagnostic computer system.

A typical procedure consists of an in-patient visit in the morning during which clinicians attach the base station apparatus to the patient and the patient swallows the capsule. The system records images beginning just prior to swallowing and records images of the GI tract until its battery completely discharges. Peristalsis propels the capsule through the GI tract. The rate of passage depends on the degree of motility. Usually, the small intestine is traversed in 4 to 8 hours. After a prescribed period, the patient returns the data recorder to the clinician who then uploads the data onto a computer for subsequent viewing and analysis. The capsule is passed in time through the rectum and need not be retrieved.

The capsule camera allows the GI tract from the esophagus down to the end of the small intestine to be imaged in its entirety, although it is not optimized to detect anomalies in the stomach. Color photographic images are captured so that anomalies need only have small visually recognizable characteristics, not topography, to be detected. The procedure is pain-free and requires no anesthesia. Risks associated with the capsule passing through the body are minimal—certainly the risk of perforation is much reduced relative to traditional endoscopy. The cost of the procedure is less than for traditional endoscopy due to the decreased use of clinician time and clinic facilities and the absence of anesthesia.

As the capsule camera becomes a viable technology for inspecting gastrointestinal tract, various methods for storing the image data have emerged. For example, U.S. Pat. No. 4,278,077 discloses a capsule camera that stores image data in chemical films. U.S. Pat. No. 5,604,531 discloses a capsule camera that transmits image data by wireless to an antenna array attached to the body or provided in the inside a vest worn by a patient. U.S. Pat. No. 6,800,060 discloses a capsule camera that stores image data in an expensive atomic resolution storage (ARS) device. The stored image data could then be downloaded to a workstation, which is normally a personal computer for analysis and processing. The results may then be reviewed by a physician using a friendly user interface. However, these methods all require a physical media conversion during the data transfer process. For example, image data on chemical film are required to be converted to a physical digital medium readable by the personal computer. The wireless transmission by electromagnetic signals requires extensive processing by an antenna and radio frequency electronic circuits to produce an image that can be stored on a computer. Further, both the read and write operations in an ARS device rely on charged particle beams.

A capsule camera using a semiconductor memory device, whether volatile or nonvolatile, has the advantage of being capable of a direct interface with both a CMOS or CCD image sensor, where the image is captured, and a personal computer, where the image may be analyzed. The high density and low manufacturing cost achieved in recent years made semiconductor memory the most promising technology for image storage in a capsule camera. According to Moore's law, which is still believed valid, density of integrated circuits double every 24 months. Even though CMOS or CCD sensor resolution doubles every few years, the data density that can be achieved in a semiconductor memory device at least keeps pace with the increase in sensor resolution. Alternatively, if the same resolution is kept, a larger memory allows more images to be stored and therefore can accommodate a higher frame rate.

When images are transmitted over a wireless link, the vast amount of data transmitted over many hours of capturing images as the capsule travel through the body severely tax battery power. Also, in the prior art, the bandwidth required for the transmitting image data at the desired data rate easily exceeds the limited bandwidth allocated by the regulatory agency (e.g., Federal Communication Commission) for medical applications. Alternatively, when an on-board storage is provided in the capsule camera, the uncompressed image files can easily require multiple gigabytes of storage, which is difficult to provide in a capsule camera. Therefore, regardless of whether the images are stored on-board or transmitted wirelessly to a receiver as the images are captured, storage or transmission bandwidth and power requirements are reduced when suitable data compression techniques are used.

At the same time, examining the large number of images captured by a capsule camera (e.g., 50,000 images for an adult small intestine and over 150,000 for an adult large intestine) is very time consuming. Low patient through-put and high cost result. Even after applying some techniques for accelerating the review, physicians routinely spend 45 minutes to 2 hours to review the large number of images. Because many of the images overlap each other by substantial portions, as the physician goes over these repetitive areas, there is the risk of overlooking a significant area which otherwise should be examined. The large amount of data to examine prohibits the use of telemedicine, and even archiving and data retrieval are difficult.

### SUMMARY OF THE INVENTION

According to one embodiment of the present invention, a method for intraframe image compression identify a reference block by minimizing a cost function which depends on an activity metric. The intraframe image compression includes (a) dividing the image into blocks; (b) selecting a block according to a predetermined sequence; and (c) processing each selected block by: (1) identifying a reference block from previously processed blocks in the image according to an activity metric; and (2) using the reference block, compressing the selected block. The selected block may be compressed by compressing a difference between the selected block and the reference block, where the difference may be offset by a predetermined value. The activity metric depends on elements of a difference block, which is a block in which elements are each a difference between an element of the current image frame and a corresponding element of the reference frame.

According to one embodiment of the present invention, the activity metric is a function of the sum of (a) the sum over all rows of all differences between two successive consecutive elements of each row of the difference block; and (b) the sum over all columns of all differences between two consecutive elements of each column of the difference block. The reference block is identified by minimizing a cost function based on the activity metric and either a sum of absolute differences function or a sum of square differences function. The cost function may be a weighted sum of the activity metric and either a sum of absolute differences function or a sum of square differences function, or a weighted sum of the activity function and either a sum of absolute differences function or a sum of square differences function.

According to another embodiment of the present invention, a circuit may be provided for identification of a reference frame for video compression of a current image frame. In the circuit, a champion register holds a current parameter value, the champion register receiving a load signal and an input value which becomes the current parameter value when the load signal is asserted. A comparator receives the activity metric and the current parameter value for providing the activity metric and a result value indicative of whether the activity metric is less than the current parameter value; and a logic circuit which generates the load signal and provides the activity metric as the input value to the champion register in accordance with the result value.

The present invention is better understood upon consideration of the detailed description below in conjunction with the accompanying drawings.

### BRIEF DESCRIPTION OF THE DRAWINGS

FIG. 1 shows schematically capsule system 01 in the GI tract, according to one embodiment of the present invention, showing the capsule in a body cavity.

FIG. 2 is a functional block diagram of information flow during capsule camera operation in capsule system 01.

FIG. 3 is a functional block diagram illustrating the data transferring process from capsule system 01 to a workstation.

FIG. 4 is a functional block diagram illustrating the data upload process from a capsule, showing information flow from capsule system 01 to workstation 51.

FIG. 5 shows swallowable capsule system 02, in accordance with one embodiment of the present invention.

FIG. 6 is a functional block diagram of information flow of implementation 1400 of capsule system 02, during capsule camera operation.

FIG. 7 is a diagram illustrating dividing an image into 8×8 pixel blocks, according to one embodiment of the invention.

FIGS. 8A-8C are three parts of a flow chart, illustrating a compression technique according to one embodiment of the present invention.

FIG. 9 illustrates an MPEG-like image compression achieved without using a large frame buffer, in accordance with one embodiment of the present invention.

FIG. 10 illustrates the Global Motion Method for detecting advancing motion of the capsule.

FIG. 11 illustrates the Representative Point Matching (RPM) method for detecting advancing motion of the capsule.

FIG. 12 shows one method of eliminating the overlap, in one embodiment of the present invention.

FIG. 13A shows pixel block 1301 and search area 1303.

FIG. 13B shows search areas 1303 and 1307 of pixel block 1301 and adjacent block 1302, respectively.

FIG. 14A shows search area 1401 in the reference frame for a row of pixel blocks 1402-1 to 1402-n in the current frame.

FIG. 14B shows search areas 1401 and 1404 in the reference frame for respectively a row of pixel blocks 1402-1 to 1402-n and an adjacent row of pixel blocks 1403-1 to 1403-n in the current frame.

FIG. 15 is an example of a 3-dimensional histogram of movement vector occurrences (weighted by activity), according to one embodiment of the present invention.

FIGS. 16A and 16B are histograms of the x and y displacements used in a method for deriving a movement vector, in accordance with one embodiment of the present invention.

FIG. 17A shows ring-shape section 1701, which represents a short section of the GI tract; ring-shape section 1701 may be opened up in a curved form 1702, and stretched into rectangular form 1703 to facilitate viewing.

FIG. 17B shows “actual reality” image 1741, which may be transformed into rectangular actual reality image 1742 for viewing convenience, according to one embodiment of the present invention.

FIG. 18 is a block diagram showing a design of best match selector 500, according to one embodiment of the present invention.

To facilitate cross-referencing among the figures, like elements in the figures are provided like reference numerals.

### DETAILED DESCRIPTION OF THE INVENTION

The Copending patent applications disclose a capsule camera that overcomes many deficiencies of the prior art. Today, semiconductor memories are low-cost, low-power, easily available from multiple sources, and compatible with application specific integrated circuit (ASIC), sensor electronics (i.e., the data sources), and personal computers (i.e., the data destination) without format conversion devices. One embodiment of the present invention allows images to be stored in an “on-board storage” using semiconductor memories which may be manufactured using industry standard memory processes, or readily available memory processes. To optimize the use of the semiconductor memory device for diagnostic image storage, a method of the present invention may eliminate overlap area between successive images to reduce the storage requirement.

According to one embodiment of the present invention, a specialized frame buffer is provided. As a 640×480 resolution VGA-type image has 300,000 pixels, and if each such pixel is represented equally by one byte of data (e.g., 8 bits), the image requires a 2.4 M-bit frame buffer (“regular frame buffer”). Because of its physical and power constraints, in practice, a capsule camera can provide only a fraction of the regular frame buffer. A highly efficiency image compression¹ algorithm to reduce the storage requirement may be provided, taking into consideration the limited processing power and limited memory size available in the capsule. As discussed in the Copending patent application, “partial frame buffers” may be provided, with each partial frame buffer being significantly smaller than a regular frame buffer. ¹ The digital image may be compressed using a suitable lossy compression technique.

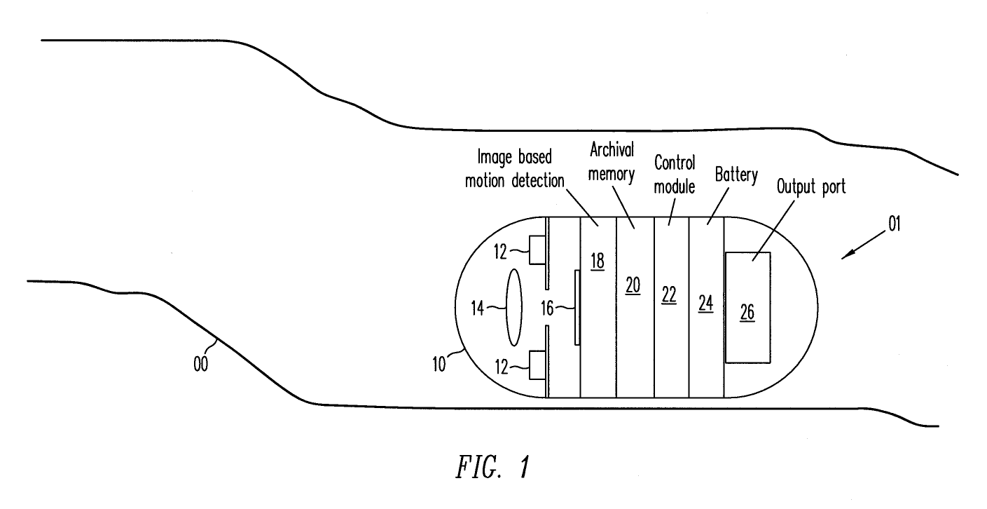

FIG. 1 shows a swallowable capsule system 01 inside body lumen 00, in accordance with one embodiment of the present invention. Lumen 00 may be, for example, the colon, small intestines, the esophagus, or the stomach. Capsule system 01 is entirely autonomous while inside the body, with all of its elements encapsulated in a capsule housing 10 that provides a moisture barrier, protecting the internal components from bodily fluids. Capsule housing 10 is transparent, so as to allow light from the light-emitting diodes (LEDs) of illuminating system 12 to pass through the wall of capsule housing 10 to the lumen 00 walls, and to allow the scattered light from the lumen 00 walls to be collected and imaged within the capsule. Capsule housing 10 also protects lumen 00 from direct contact with the foreign material inside capsule housing 10. Capsule housing 10 is provided a shape that enables it to be swallowed easily and later to pass through the GI tract. Generally, capsule housing 10 is sterile, made of non-toxic material, and is sufficiently smooth to minimize the chance of lodging within the lumen.

As shown in FIG. 1, capsule system 01 includes illuminating system 12 and a camera that includes optical system 14 and image sensor 16. An image captured by image sensor 16 may be processed by image-based motion detector 18, which determines whether the capsule is moving relative to the portion of the GI tract within the optical view of the camera. Image-based motion detector 18 may be implemented in software that runs on a digital signal processor (DSP) or a central processing unit (CPU), in hardware, or a combination of both software and hardware. Image-based motion detector 18 may have one or more partial frame buffers, a semiconductor non-volatile archival memory 20 may be provided to allow the images to be retrieved at a docking station outside the body, after the capsule is recovered. System 01 includes battery power supply 24 and an output port 28. Capsule system 01 may be propelled through the GI tract by peristalsis.

Illuminating system 12 may be implemented by LEDs. In FIG. 1, the LEDs are located adjacent the camera's aperture, although other configurations are possible. The light source may also be provided, for example, behind the aperture. Other light sources, such as laser diodes, may also be used. Alternatively, white light sources or a combination of two or more narrow-wavelength-band sources may also be used. White LEDs are available that may include a blue LED or a violet LED, along with phosphorescent materials that are excited by the LED light to emit light at longer wavelengths. The portion of capsule housing 10 that allows light to pass through may be made from bio-compatible glass or polymer.

Optical system 14, which may include multiple refractive, diffractive, or reflective lens elements, provides an image of the lumen walls on image sensor 16. Image sensor 16 may be provided by charged-coupled devices (CCD) or complementary metal-oxide-semiconductor (CMOS) type devices that convert the received light intensities into corresponding electrical signals. Image sensor 16 may have a monochromatic response or include a color filter array such that a color image may be captured (e.g. using the RGB or CYM representations). The analog signals from image sensor 16 are preferably converted into digital form to allow processing in digital form. Such conversion may be accomplished using an analog-to-digital (A/D) converter, which may be provided inside the sensor (as in the current case), or in another portion inside capsule housing 10. The A/D unit may be provided between image sensor 16 and the rest of the system. LEDs in illuminating system 12 are synchronized with the operations of image sensor 16. One function of control module 22 is to control the LEDs during image capture operation.

Motion detection module 18 selects an image to retain when the image shows enough motion relative to the previous image in order to save the limited storage space available. The images are stored in an on-board archival memory system 20. The output port 26 shown in FIG. 1 is not operational in vivo but uploads data to a work station after the capsule is recovered, having passed from the body.

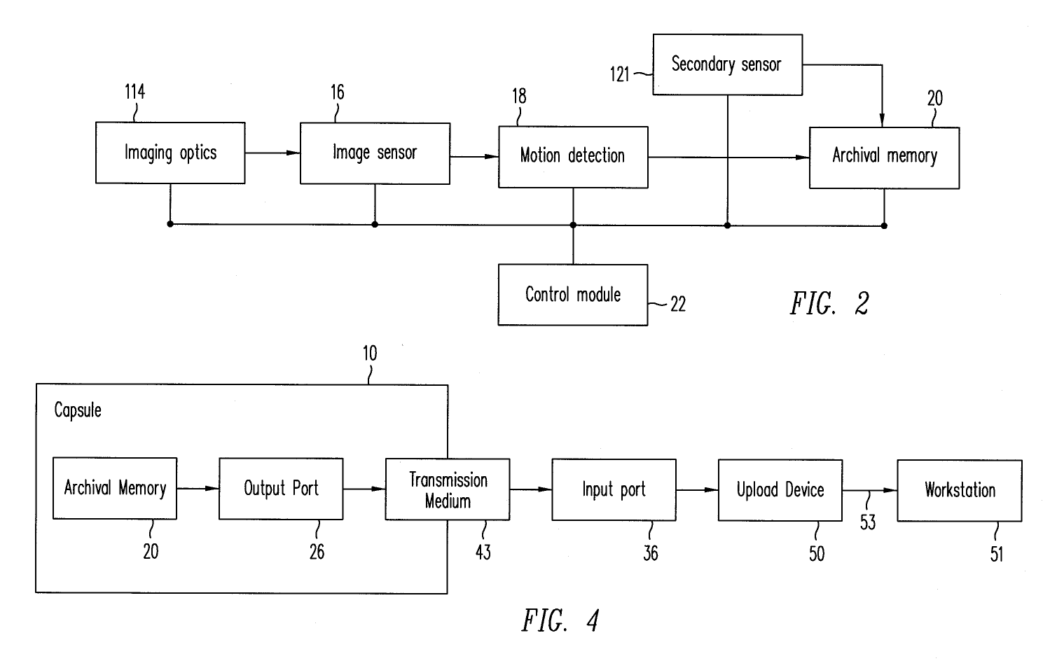

FIG. 2 is a functional block diagram of information flow during capsule camera operation. Except for optical system 114, all of these functions may be implemented on a single integrated circuit. As shown in FIG. 2, optical system 114, which represents both illumination system 12 and optical system 14, provides an image of the lumen wall on image sensor 16. Some images will be captured but not stored in the archival memory 20, based on the motion detection circuit 18, which decides whether or not the current image is sufficiently different from the previous image. An image may be discarded if the image is deemed not sufficiently different from a previous image. Secondary sensors (e.g., pH, thermal, or pressure sensors) may be provided. The data from the secondary sensors are processed by the secondary sensor circuit 121 and provided to archival memory system 20. Measurements made may be provided time stamps. Control module 22, which may consist of a microprocessor, a state machine or random logic circuits, or any combination of these circuits, controls the operations of the modules. For example, control module 22 may use data from image sensor 16 or motion detection circuit 18 to adjust the exposure of image sensor 16.

Archival memory system 20 can be implemented by one or more non-volatile semiconductor memory devices. Archival memory system 20 may be implemented as an integrated circuit separate from the integrated circuit on which control module 22 resides. Since the image data are digitized for digital image processing techniques, such as motion detection, memory technologies that are compatible with digital data are selected. Of course, semiconductor memories that are mass-produced using planar technology (which represents virtually all integrated circuits today) are the most convenient. Semiconductor memories are most compatible because they share common power supply with the sensors and other circuits in capsule system 01, and require little or no data conversion when interfaced with an upload device at output port 26. Archival memory system 20 preserves the data collected during the operation, after the operation while the capsule is in the body, and after the capsule has left the body, up to the time the data is uploaded. This period of time is generally less than a few days. A non-volatile memory is preferred because data may be held without power consumption, even after the capsule's battery power has been exhausted. Suitable non-volatile memory includes flash memories, write-once memories, or program-once-read-once memories. Alternatively, archival memory system 20 may be volatile and static (e.g., a static random access memory (SRAM) or its variants, such as VSRAM, PSRAM). Alternately, the memory could be a dynamic random access memory (DRAM).

Archival memory 20 may be used to hold any initialization information (e.g., boot-up code and initial register values) to begin the operations of capsule system 01. The cost of a second non-volatile or flash memory may therefore be saved. That portion of the non-volatile memory may also be written over during operation to store the selected captured images.

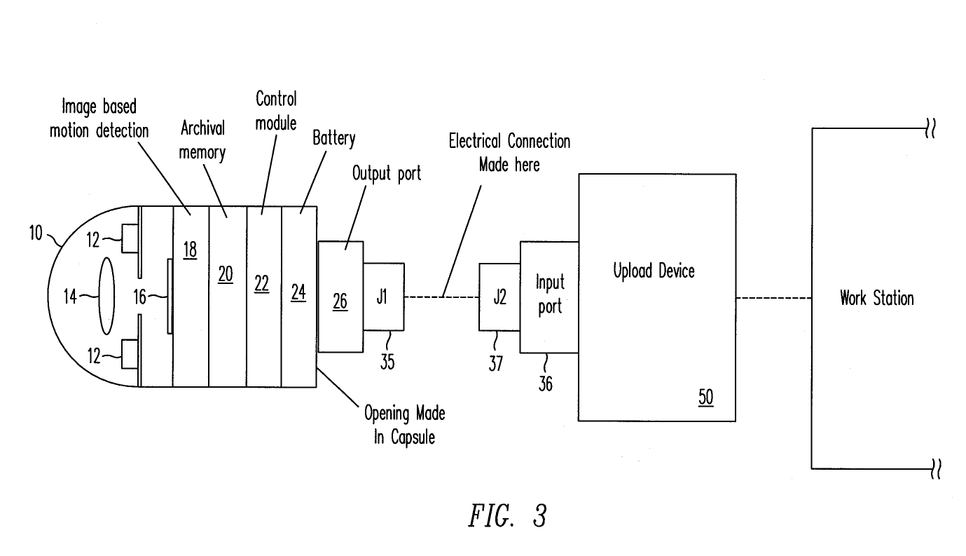

After the capsule passes from the body, it is retrieved. Capsule housing 10 is opened and input port 16 is connected to an upload device for transferring data to a computer workstation for storage and analysis. The data transferring process is illustrated in the functional block diagram of FIG. 3. As shown in FIG. 3, output port 26 of capsule system 01 includes an electrical connector 35 that mates with connector 37 at an input port of an upload device. Although shown in FIG. 3 to be a single connector, these connectors may be implemented as several conductors to allow data to be transferred serially or over a parallel bus, and so that power may be transferred from the upload device to the capsule, thereby obviating the need for the capsule battery to provide power for data uploading.

To make the electrical connection to output port 26, capsule housing 10 may be breached by breaking, cutting, melting, or another technique. Capsule housing 10 may include two or more parts that are pressure-fitted together, possibly with a gasket, to form a seal, but that can be separated to expose connector 35. The mechanical coupling of the connectors may follow the capsule opening process or may be part of the same process. These processes may be achieved manually, with or without custom tooling, or may be performed by a machine automatically or semi-automatically.

FIG. 4 illustrates the data transfer process, showing information flow from capsule system 01 to workstation 51, where it is written into a storage medium such as a computer hard drive. As shown in FIG. 4, data is retrieved from archival memory 20 over transmission medium 43 between output port 26 of capsule system 01 and input port 36 of upload device 50. The transmission link may use established or custom communication protocols. The transmission medium may include the connectors 35 and 37 shown in FIG. 3 and may also include cabling not shown in FIG. 3. Upload device 50 transfers the data to a computer workstation 51 through interface 53, which may be implemented by a standard interface, such as a USB interface. The transfer may also occur over a local-area network or a wide-area network. Upload device 50 may have memory to buffer the data.

A desirable alternative to storing the images on-board is to transmit the images over a wireless link. In one embodiment of the present invention, data is sent out through wireless digital transmission to a base station with a recorder. Because available memory space is a lesser concern in such an implementation, a higher image resolution may be used to achieve higher image quality. Further, using a protocol encoding scheme, for example, data may be transmitted to the base station in a more robust and noise-resilient manner. One disadvantage of the higher resolution is the higher power and bandwidth requirements. One embodiment of the present invention transmits only selected images using substantially the selection criteria discussed above for selecting images to store. In this manner, a lower data rate is achieved, so that the resulting digital wireless transmission falls within the narrow bandwidth limit of the regulatory approved Medical Implant Service Communication (MISC) Band. In addition, the lower data rate allows a higher per-bit transmission power, resulting in a more error-resilient transmission. Consequently, it is feasible to transmit a greater distance (e.g. 6 feet) outside the body, so that the antenna for picking up the transmission is not required to be in an inconvenient vest, or to be attached to the body. Provided the signal complies with the MISC requirements, such transmission may be in open air without violating FCC or other regulations.

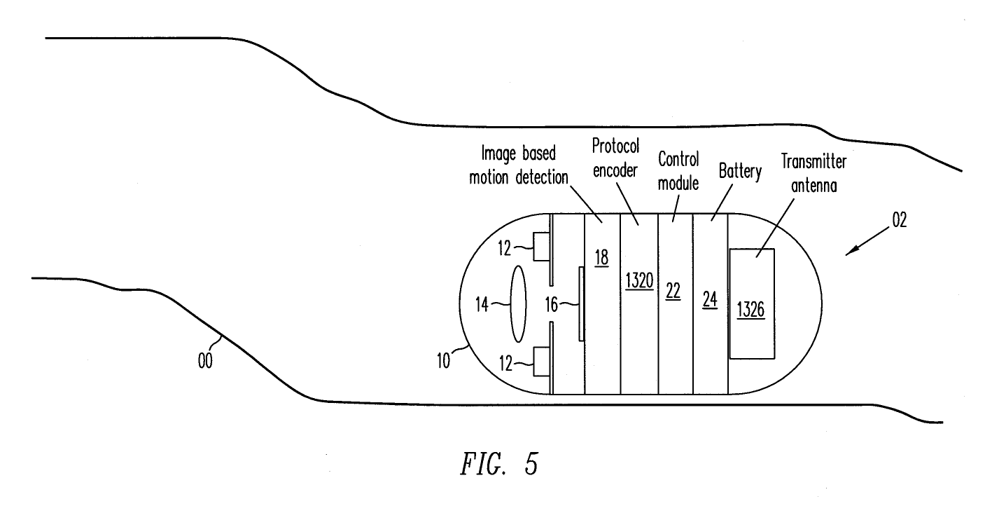

FIG. 5 shows swallowable capsule system 02, in accordance with one embodiment of the present invention. Capsule system 02 may be constructed substantially the same as capsule system 01 of FIG. 1, except that archival memory system 20 and output port 26 are no longer required. Capsule system 02 also includes communication protocol encoder 1320 and transmitter 1326 that are used in the wireless transmission. The elements of capsule 01 and capsule 02 that are substantially the same are therefore provided the same reference numerals. Their constructions and functions are therefore not described here again. Communication protocol encoder 1320 may be implemented in software that runs on a DSP or a CPU, in hardware, or a combination of software and hardware, Transmitter 1326 includes an antenna system for transmitting the captured digital image.

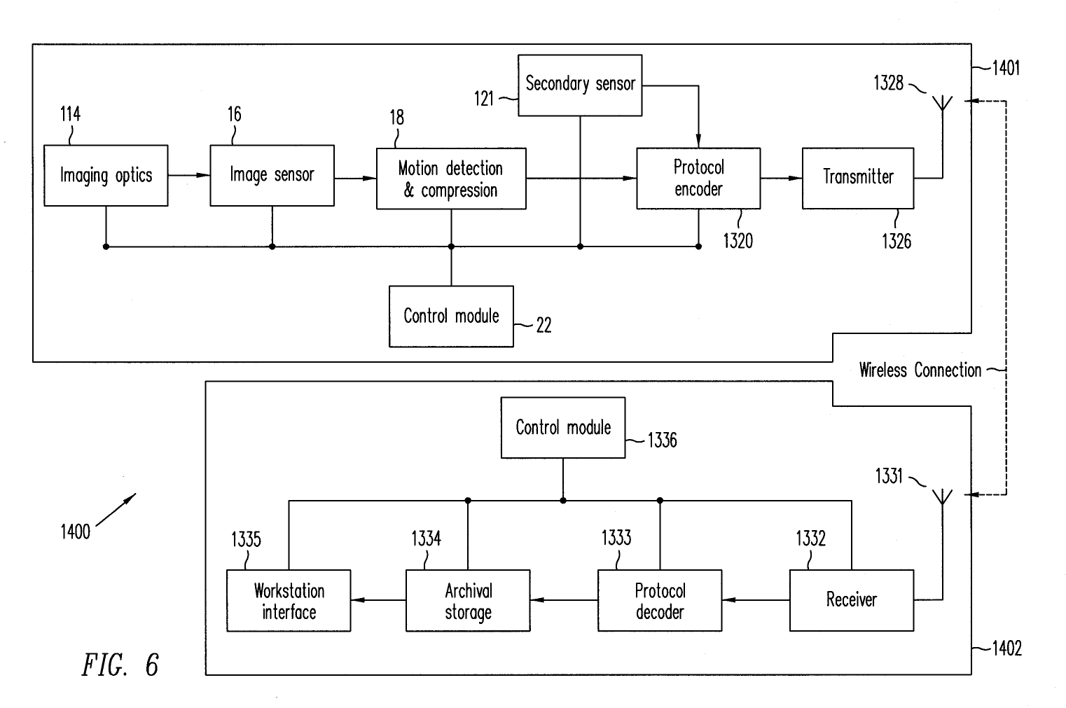

FIG. 6 is a functional block diagram of information flow of implementation 1400 of capsule system 02, during capsule camera operation. Functions shown in blocks 1401 and 1402 are respectively the functions performed in the capsule and at an external base station with a receiver 1332. With the exception of optical system 114 and antenna 1328, the functions in block 1401 may be implemented on a single integrated circuit. As shown in FIG. 6, optical system 114, which represents both illumination system 12 and optical system 14, provides an image of the lumen wall on image sensor 16. Some images will be captured but not transmitted from capsule system 02, based on the motion detection circuit 18, which decides whether or not the current image is sufficiently different from the previous image. An image may be discarded if the image is deemed not sufficiently different from the previous image. An image selected for transmission is processed by protocol encoder 1320 for transmission. Secondary sensors (e.g., pH, thermal, or pressure sensors) may be provided. The data from the secondary sensors are processed by the secondary sensor circuit 121 and provided to protocol encoder 1320. Measurements made may be provided time stamps. Images and measurements processed by protocol encoder 1320 are transmitted through antenna 1328. Control module 22, which may consist of a microprocessor, a state machine or random logic circuits, or any combination of these circuits, controls the operations of the modules in capsule system 02. As mentioned above, the benefits of selecting captured images based on whether the capsule has moved over a meaningful distance or orientation is also applicable to select captured images for wireless transmission. In this manner, an image that does not provide additional information than the previously transmitted one is not transmitted. Precious battery power that would otherwise be required to transmit the image is therefore saved.

As shown in FIG. 6, a base station represented by block 1402 outside the body receives the wireless transmission using antenna 1331 of receiver 1332. Protocol decoder 1333 decodes the transmitted data to recover the captured images. The recovered captured images may be stored in archival storage 1334 and provided later to a workstation where a practitioner (e.g., a physician or a trained technician) can analyze the images. Control module 1336, which may be implemented the same way as control module 22, controls the functions of the base station. Capsule system 02 may use compression to save transmission power. If compression is used in the transmitted images in motion detector 18, a decompression engine may be provided in base station 1402, or the images may be decompressed in the workstation when they are viewed or processed. A color space converter may be provided in the base station, so that the transmitted images may be represented in a different space used in motion detection than the color space used for image data storage.

In this detailed description, the terms “video compression” and “image compression” are generally used interchangeably, unless the context otherwise dictates. In this regard, video may be seen as a sequence of images with each image associated with a point in time.

Popular image compression algorithms fall into two categories. The first category, based on frame-by-frame compression (e.g., JPEG), removes intra-frame redundancy. The second category—based at least in part on the differences between frames (e.g., MPEG)—removes both intra-frame and inter-frame redundancies. The second category (“MPEG-like”) compression algorithms, which are more complex and require multiple frame buffers, can achieve a higher compression ratio. A frame buffer for a 300 k pixel image requires at least a 2.4 M-bit random access memory. Conventional MPEG-like algorithms that require multiple frame buffers are therefore impractical, considering the space and power constraints in a capsule camera. Motion compression algorithms are widely available. The present invention therefore applies motion-based compression, without requiring full frame buffer support required in the prior art and eliminate overlaps between images.

One embodiment of the present invention takes advantage that a typical small intestine is 5.6 meters long for an adult. In the course of traveling this length, a capsule camera may take more than 50,000 images (i.e., on the average, each image captures 0.1 mm of new area not already captured in the previous image). The field of view of an actual image covers many times this length (e.g., 5 mm). Therefore, guided by a movement vector, a greatly enhanced compression ratio may be achieved by storing only non-overlapped regions between successive images. This method can be combined with, for example, an MPEG-like compression algorithm, which already takes advantage eliminating temporal redundancy. In one embodiment of the present invention, the motion vectors detected in the compression process could be used for eliminating overlapped portions between successive images. Further, by eliminating overlapped areas, the images may be stitched together to present a continuous real image of the GI tract (“an actual reality”) for the physician to examine. The time required to review such an image would be a matter of a few minutes, without risking overlooking an important area. Consequently, a physician may be able to review such an image remotely, thereby enabling the use of telemedicine in this area. Further, because only the relevant data is presented, archival and retrieval may be carried out quickly and inexpensively.

The present invention requires only a buffer memory for temporarily storing images for motion detection, to determine a desired frame rate, and to determine where the field of view with the previous image overlaps. Special techniques avoid the need for a conventional frame buffer that stores data for more than one frame. Instead, only partial frame buffers are needed. Redundancies in an image are discarded, storing in the on-board archival memory, or transmitting by wireless communication, only the desired and non-redundant images and information.

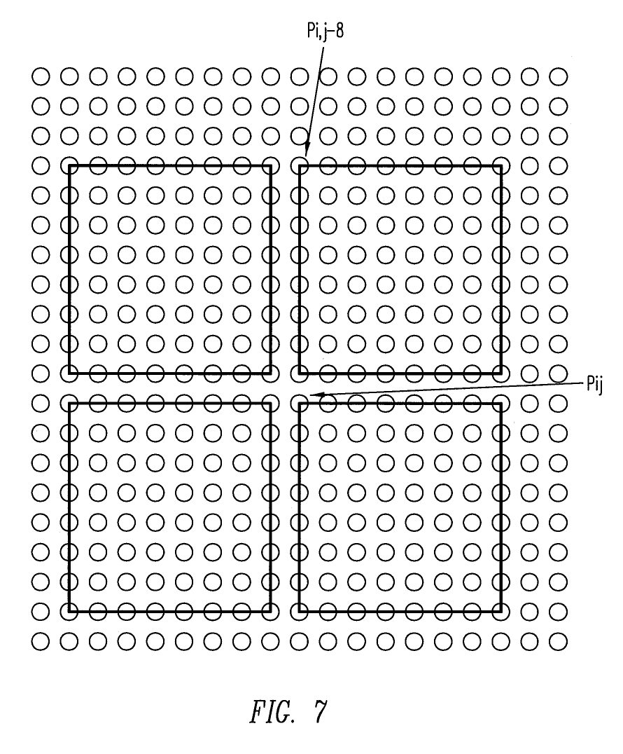

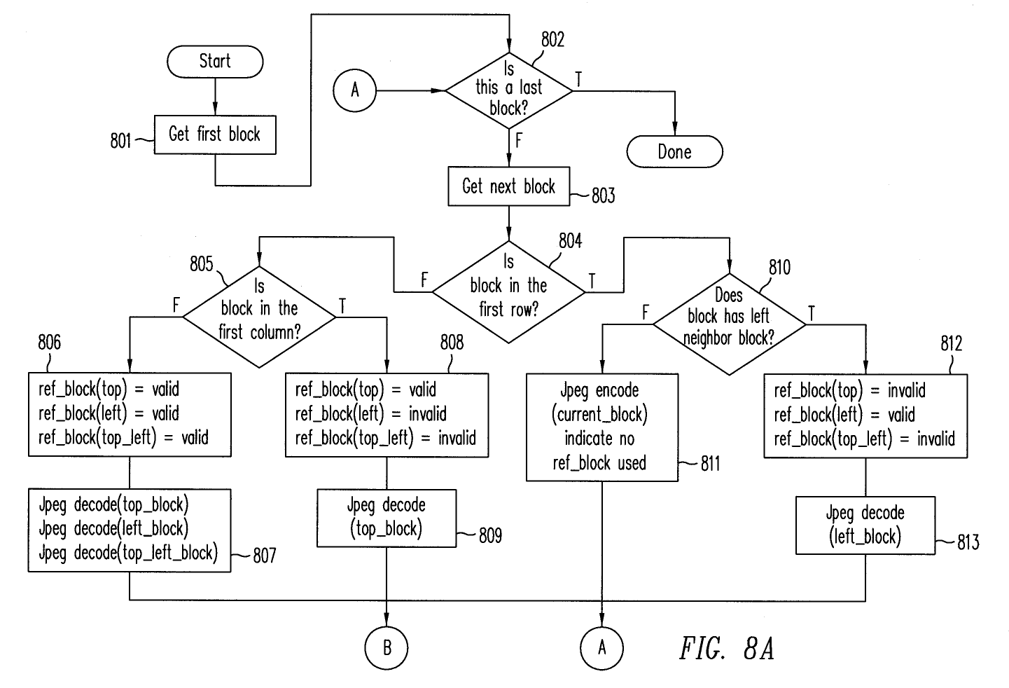

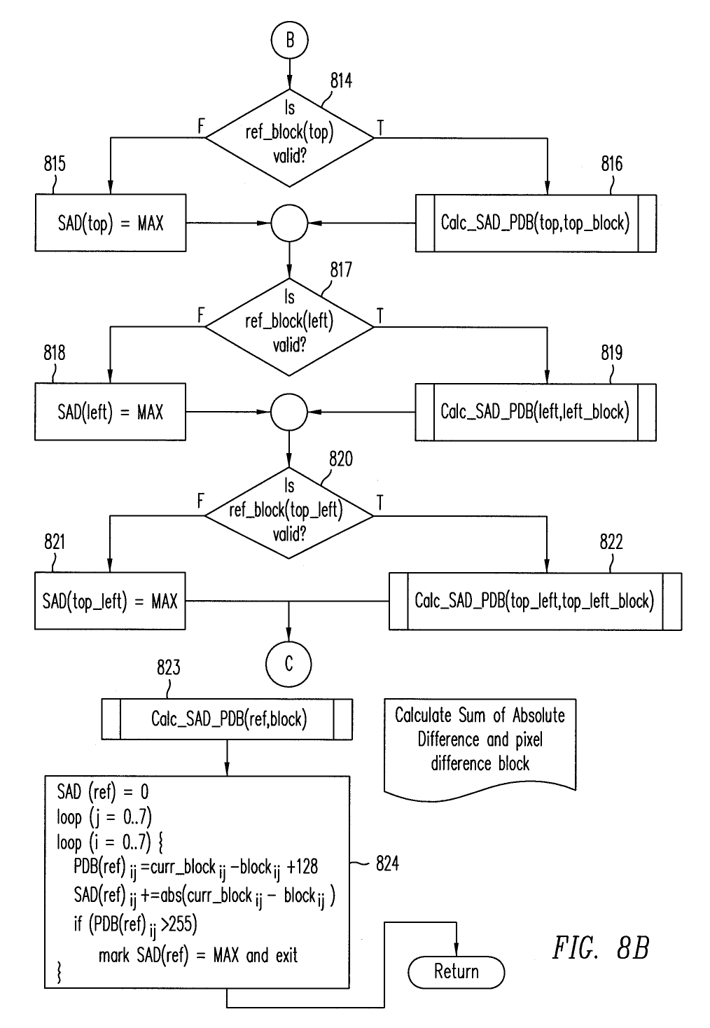

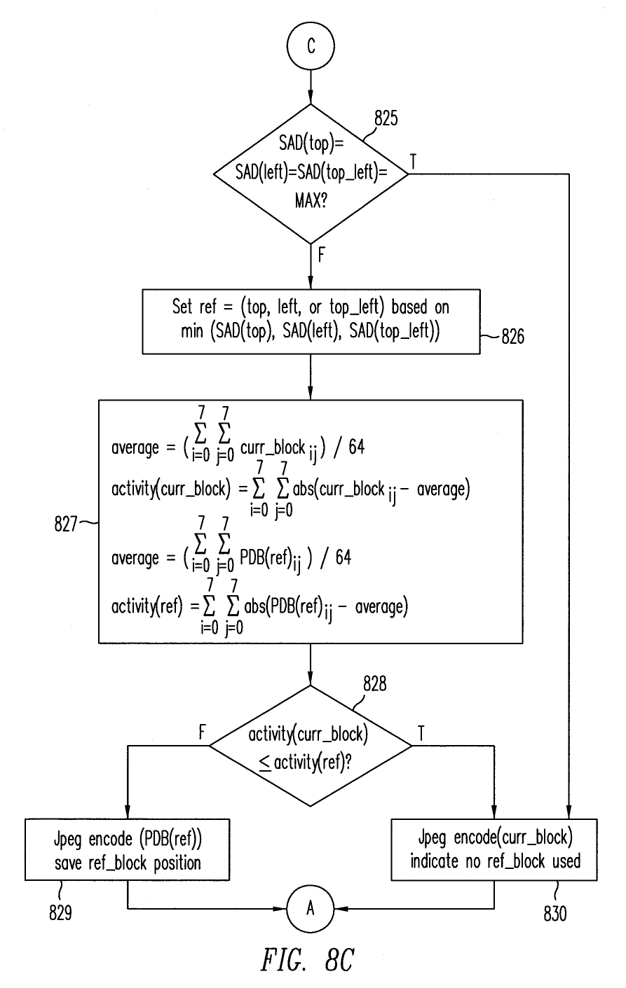

One embodiment of the present invention, which improves a still-image compression technique (“JPEG-like compression algorithm”), is illustrated by FIGS. 7 and 8A-8C. In this embodiment, as in a JPEG compression, an image is divided into 8×8 pixel blocks (see FIG. 7). Dividing by block facilitate processing of the image data, for example, by a discrete cosine transform (DCT) in the frequency domain. In FIG. 7, each 8×8 block Pᵢⱼ may be labeled by the rows and column positions (i, j) of a selected pixel in the block (e.g., the pixel at the top-left position of the block). As in a JPEG compression, encoding and decoding may progress block by the block from the top-left to the bottom-right of an image. As shown in FIG. 7, block Pᵢⱼ is compared in turn with a predetermined number (e.g., 3) of previously processed neighboring blocks (e.g., blocks Pd₍ᵢ₋₈₎ⱼ, P₍ᵢ₋₈₎₍ⱼ₋₈₎, and Pᵢ₍ⱼ₋₈₎). FIG. 8A illustrates, for each block to be processed, identifying the previously processed neighboring blocks. As shown in FIG. 8A, if a block is in the first row and in the first column (as determined by steps 804, 810 and 811), that block is compressed or encoded under a JPEG-like algorithm without using a reference block. If the block is in the first row and has a previously processed neighboring block on its left (as determined by steps 804, 810 and 812), the previously processed neighboring block is decompressed or decoded at step 813 in preparation for further processing. The further processing begins at Step B of FIG. 8B. If a block is not in the first row, but in the first column (as determined by steps 804, 805 and 808), the neighboring block immediately above it may serve as a reference block. In that case, the neighboring block above it is decoded or decompressed for further processing at Step B. If a block has neighboring blocks both above it and to its left (as determined by steps 804, 805 and 806), all these neighboring blocks are decoded or decompressed for further processing at Step B.

At Step B (FIG. 8B), for each previously processed neighboring block eligible to serve as a reference block, a method of the present invention compares the pixels in the current block with that previously processed neighboring block in the same image to determine if the previously processed neighboring block can be used as a reference block. Therefore, for each eligible previously processed neighboring block, steps 814-822 each compute a sum of the absolute differences (SAD) between corresponding pixels of the blocks and the neighboring block P′ (e.g., block P₍ᵢ₋₈₎ⱼ). SAD provides a measure of dissimilarity between corresponding elements of compared blocks. Step 824 of FIG. 8B shows the sum

$$SAD = {\sum }_{m = 0}^{7} {\sum }_{n = 0}^{7} \vert {p}_{mn} - {p}_{mn}^{′} \vert$$

of corresponding pixels pₘₙ of block Pᵢⱼ and p′ₘₙ of neighboring block P′. Block P′ may be, for example, a block which is immediate to the left of block Pᵢⱼ.

In addition, at step 824 of FIG. 8B, block PDBᵢⱼ is constructed from the 8×8 difference values pdbₘₙ=pₘₙ−p′ₘₙ+128 computed using each pixel pₘₙ in the current block and the corresponding pixel p′ₘₙ in the reference block. If any of the pdbₘₙ values exceeds 255, the potential reference block is considered sufficiently different from the current pixel block that it is disqualified from being selected as the reference block.

When all the neighboring blocks are processed, the method advances to Step C, which is shown in FIG. 8C. If none of the neighboring blocks is eligible to serve as a reference block (as determined by step 825 of FIG. 8C), the current block is compressed or encoded in JPEG without a reference block (step 830). Otherwise, the neighboring block corresponding to the smallest sum SAD is selected (as determined by steps 825 and 826). At step 827, averages and activity statistics are computed for both current block Pᵢⱼ and difference block² PDBᵢⱼ. That is, average

$$\overline{p} = \frac{1}{64} {\sum }_{m = 0}^{7} {\sum }_{n = 0}^{7} {p}_{mn}$$

for the pixels pₘₙ of current block Pᵢⱼ, average

$$\overline{d} = \frac{1}{64} {\sum }_{m = 0}^{7} {\sum }_{n = 0}^{7} {pdb}_{mn}$$

for the pixels of difference block PDBᵢⱼ, activity

$${A}_{p} = {\sum }_{m = 0}^{7} {\sum }_{n = 0}^{7} {p}_{mn} - \overline{p}$$

for current block Pᵢⱼ and activity

$${A}_{pdb} = {\sum }_{m = 0}^{7} {\sum }_{n = 0}^{7} {pdb}_{mn} - \overline{d}$$

for difference block PDBᵢⱼ are computed. At step 828, if activity Aₚ of current block Pᵢⱼ is greater than or equal to activity A_{pdb} of difference block PDBᵢⱼ, difference block PDBᵢⱼ—rather than current block Pᵢⱼ—is compressed or encoded; otherwise, current block Pᵢⱼ is compressed or encoded under JPEG without a reference block. ² A difference block is a block containing an element-by-element difference between a current block and a reference block.

The selected neighboring block that serves as the reference block is indicated by a saved position reference relative to the current block (step 829). For each block to be encoded, if three previously processed neighboring blocks are considered, 2 bits encode the position of the selected reference block. If up to 7 previously processed blocks (i.e., some blocks are not necessarily immediately adjacent) are considered, three bits encode the position reference of the reference block. These position reference bits may be placed in the compressed data stream or at an ancillary data section, for example.

According to the method illustrated in FIGS. 8A-8C, as only a small portion of the image (i.e., the neighboring blocks eligible to be selected as a reference block) need to be in decompressed form, the size of the frame buffer necessary to hold the decompressed candidate reference frames for the operations of FIGS. 8A-8C is small compared to the decompressed size of the total image.

During decoding, the pixel values of the reference block are added to the corresponding difference values (i.e., PDBᵢⱼ) to recover the pixel values of current block Pᵢⱼ. Because the decoded values of the reference block may be slightly different from the values used in the encoding process, the sum of absolute differences computed to select the reference block is preferably computed using the decoded values, rather the values computed prior to the encoding. JPEG compression is also applied on the basis of the decoded values. In this way, with a slight overhead, the JPEG compression ratio may be enhanced. This method therefore maintains a small silicon area, a low power dissipation, and avoids the need for a frame or partial frame buffer to meet both the space and power constraints of the capsule camera.

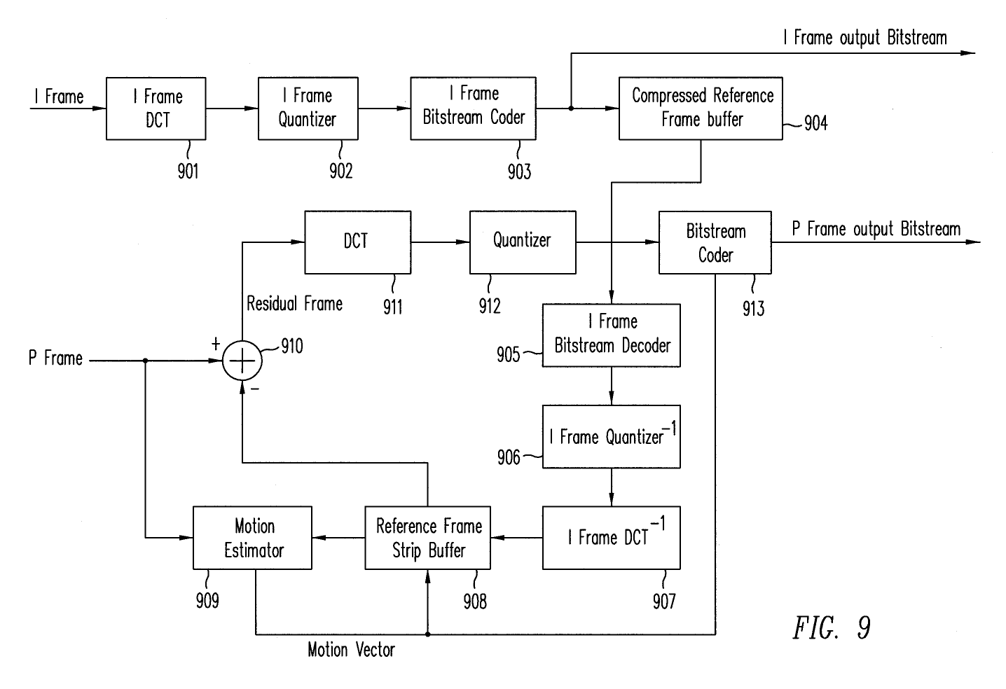

According to another embodiment of the present invention, which is illustrated by FIG. 9, an MPEG-like data compression may be achieved without using a large frame buffer. According to this embodiment, a cascaded compression using both JPEG-like and MPEG-like techniques may be achieved by first compressing the current image with a JPEG-like compression technique using moderate quantization levels. FIG. 9 shows this JPEG-like compression technique as including a DCT (step 901), a quantization (step 902), and an entropy encoding step (903). Steps 901-903 may be part of the compression procedures used in conjunction with the techniques of FIGS. 8A-8C discussed above. This JPEG-like compressed image is treated as an “I” frame in MPEG parlance. The resulting JPEG-like compressed image occupies only a frame buffer of a reduced size (step 904) without detrimental image quality degradation. As part of an interframe compression algorithm, this “I” frame may serve as a reference frame, relative to which the subsequent frame may be encoded as a residual frame (e.g., a “P” frame). To encode the subsequent frame as a “P” frame, a selected portion of the “I” frame is decompressed at the time of encoding the “P” frame, using the reverse transformations at steps 905-907 (i.e., entropy decoding, dequantization and inverse DCT). Because only a small portion of the image (e.g., a strip of the image representing the search area) is required to be decompressed for motion detection at any given time, a strip buffer provided to hold the decompressed search area of the “I” frame is also small (908). If motion detection is successful (step 909), the current frame can be compressed as a residual frame (i.e., “P” frame) by taking the pixel-by-pixel difference between corresponding blocks of the current frame and the reference frame (step 910). The “P” frame is compressed using a DCT, a quantization and an entropy encoding (steps 911-913). In this embodiment, “B” frames (which are derived from “P” and “I” frames) are not used.

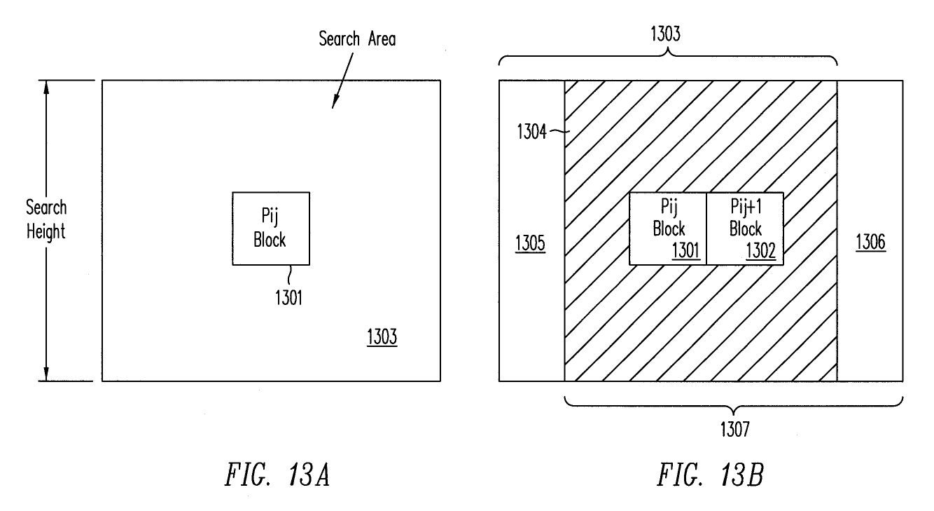

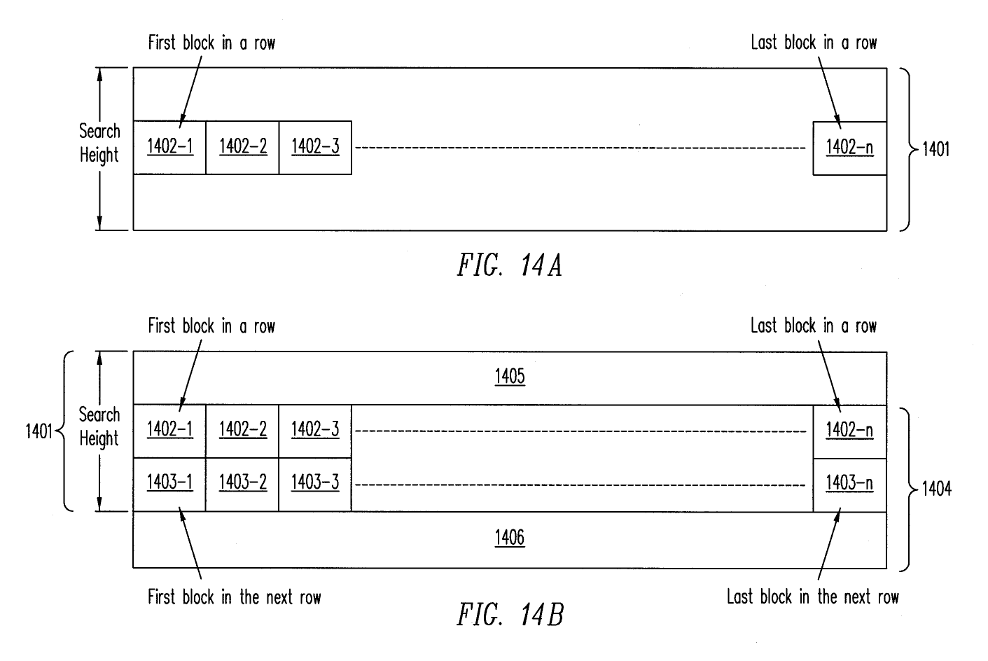

During the encoding of the current frame, the decoding of the search area in the reference I frame is performed simultaneously in real time overlapping the receipt of the current frame. FIG. 13A shows pixel block 1301 of the current frame and search area 1303 in the reference I frame. FIG. 13B shows search areas 1303 and 1307 in the reference I frame corresponding respectively to pixel block 1301 and block 1302 in the current frame. Block 1302 is positioned immediately to the right of pixel block 1301. Shaded area 1304 in FIG. 13B indicates a common area in both search areas 1303 and 1307. Specifically, search area 1303 includes area 1305 and common search area 1304, and search area 1307 includes common search area 1304 and area 1306. After block 1301 is encoded, encoding of block 1302 requires additional decoding only of block 1306, as common search area 1304 has already been decoded in the process of encoding block 1301. In fact, the buffer memory space provided to hold decoded data for area 1305 may be overwritten by the decoded data for area 1306. Areas 1305 and 1306 are each a strip that has the height of the searching area and the width of a pixel block. In one embodiment, encoding proceeds row by row in a first direction and within each row, block by block in an orthogonal direction. Therefore, after completely encoded a row of pixel blocks, encoding proceeds to the next row and the search area in the reference frame also moves down by one block. This process is illustrated by FIGS. 14A and 14B. FIG. 14A shows search area 1401 in the reference frame for a row of pixel blocks 1402-1 to 1402-n in the current frame. When encoding proceeds to the next row (i.e., pixel blocks 1403-1 to 1403-n), the new search area 1404 in the reference frame also moves down one row. Thus, the buffer memory used for holding the decoded search area 1405 may be rewritten by the decoded data from search area 1406. Only data from search area 1406 need to be decoded, as the common search area (i.e., the overlap between search area 1401 and 1402) has already been decoded when processing pixel blocks 1402-1 to 1402-n.

Thus, for each current frame to be encoded as a P frame, a reference I frame is decoded. One may suggests that the reference frame decoding wastes power, as compared to decoding the reference frame just once and be provided in a dynamic access memory (DRAM) for accesses. However, when the power required for refreshing and accessing a DRAM circuit and for driving intra-chip interconnections for access are considered, decoding of the frame in the manner described above is more power efficient, using static circuits and driving intra-chip interconnections within an ASIC.

Because the images captured by the capsule between consecutive frames are more likely to be displaced along the direction of movement (call it +x) than the perpendicular direction (y), in one embodiment, the searching area can be selected to be much larger in the x direction than in y direction. In addition, as motion is more likely in the forward direction (i.e., in +x direction), the search area may be selected to be asymmetrical (i.e., much larger in the +x direction than in the −x direction). In the case of a 360 degrees side panoramic view design, the y component need not be searched.

Movement (represented by a “movement vector”) can be detected using a number of techniques. Two examples of such techniques are the Representative Point Matching (RPM) method and the Global Motion Vector (GMV) method. Prior to applying either technique, the image may be filtered to reduce flicker and other noises.

Under the RPM method, which is illustrated in FIG. 10, a number of representative pixels (e.g. 32) are selected from each image and compared across related images. Some regions, such as the center region, may have more pixels selected than other regions (e.g., regions in the peripheral). As shown in FIG. 10, the pixels surrounding a selected representative pixel form a “matching neighborhood” (e.g., matching neighborhood 1001 of representative pixel 1002). For example, pixels within ±4 in either the x-direction or the y-direction may be selected to form a matching neighborhood. The matching neighborhoods of the selected representative pixels of the current frame are each compared with matching neighborhoods within a search area in a reference frame (i.e., an image of another time point). The search area (e.g., search area 1005) is an area in the reference frame containing a pixel (e.g., a pixel in matching neighborhood 1003) corresponding to the representative pixel. Typically, the search area is an area selected to be much larger than the matching neighborhood. The movement vector is the displacement between the matching neighborhood of the representative pixel of the current frame and the matching neighborhood in the reference frame which pixels are best matched to the pixels of the matching neighborhood of the representative pixel. The criteria for a best match could be determined in a variety of ways. The matching criteria, for example, could be based on the smallest sum of absolute difference between corresponding pixels in the matching neighborhood of the current image and in a matching neighborhood in the reference image. This best matched vector, called the motion vector for that representative pixel, is computed for each representative pixel in a current image.

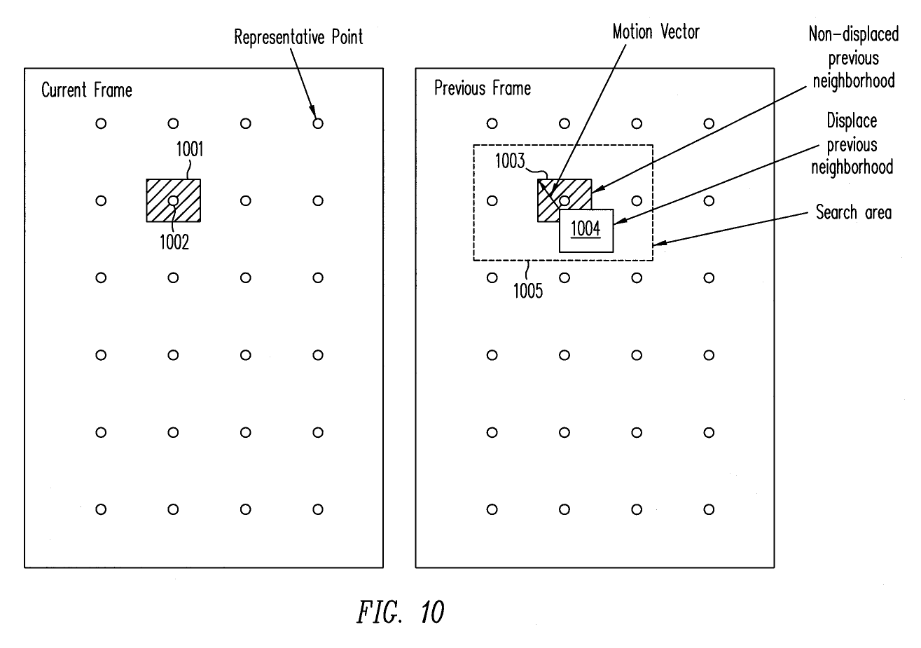

In the GMV method, which is illustrated in FIG. 11, the movement vectors are the same or similar to the motion vectors derived from MPEG-like motion estimation. For example, as shown in FIG. 11, a block 1103a is searched in search area 1105 of a previous frame. A motion vector is found in the previous frame, relative to corresponding block 1003b (i.e., the block in the current frame corresponding in position to block 1103a of the previous frame), when the pixels in block 1104 match the pixels in block 1103a.

If either method (RPM or GMV), when there are multiple best matches, an average may be taken, the movement vector closest in value and direction to the immediate prior movement vector found may be selected, arbitrarily selecting any one of the best matches, or not selecting any of the movement vectors. In the GMV method, the movement vectors could be a by-product of an MPEG-like image compression. Alternatively, as shown in FIG. 11, the area to derive movement vectors need not to be the whole frame. Instead, if buffering memory, calculation resources or power budgets are limited, only selected portions of the image (e.g., areas 1001 and 1002), rather than the entire current frame, need be selected to derive the movement vectors. The portions outside of the search areas are then compressed and the motion vectors found in the motion detection procedures may be reused to save power. Alternatively, since the general movement along GI tract is from mouth to anus (+x), motion detection can be performed in a search areas slightly shifted toward the −x direction, since the front edge in the +x direction of the current image is new information.

For either RPM or GMV, a 3-dimensional histogram may be used to identify the movement vector from a number of candidate movement vectors. The three dimensions may be, for example, x-direction displacement, y-direction displacement, and the number of motion vectors encountered having the x- and y-direction displacements. For example, position (3, −4, 6) of the histogram represents six motion vectors are scored with an x displacement 3 and a y displacement −4. The movement vector is selected, for example, as a motion vector with the highest number of occurrences, i.e., corresponding to highest number in the third axis.

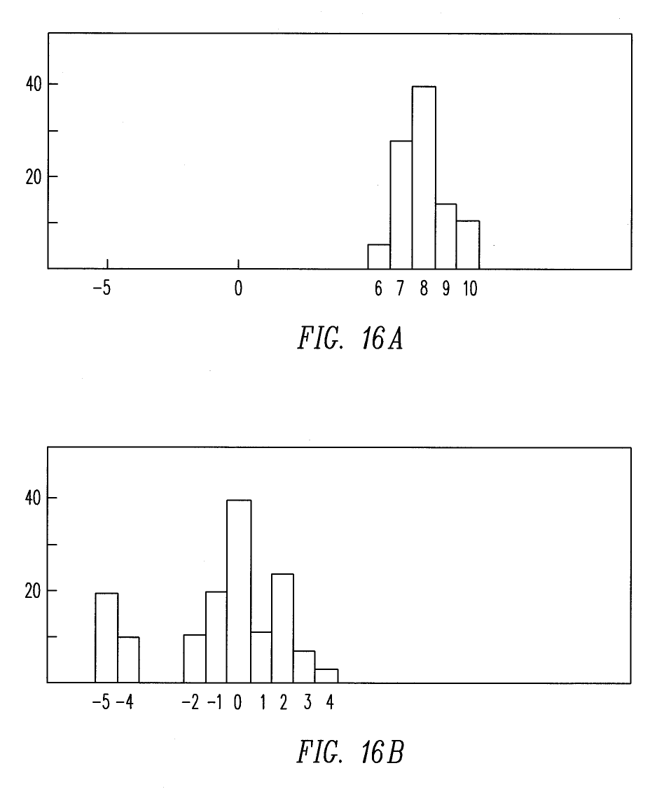

Alternatively a movement vector may also be derived using a 2-dimensional histogram, the dimensions representing the forward/reverse and the transverse directions. The x-displacement for the movement vector is the most encountered displacement in the forward or reverse direction and the y-displacement of the movement vector is the most encountered displacement for the perpendicular direction. FIGS. 16A and 16B are histograms of the x and y displacements for this method. As shown in FIG. 16A, the most encountered displacement in the x direction is 8. Similarly, as shown in FIG. 16B, the most encountered displacement in the y direction is 0. Therefore, the movement vector (8, 0) is thus adopted most probable.

If there are two or more peak points in the GMV or RPM methods, an average of the peak points, the one closest to the immediately prior movement vector, or any motion vector may be selected. The movement vector may also be declared not found in the current image.

Additionally, homogeneous matching neighborhoods (for RPM) or blocks (for GMV) can produce an incorrect matching. Matching neighborhoods and blocks with high frequency components are preferred. Therefore different weights for searching neighborhoods or blocks with different complexities may be used in one embodiment. A variety of methods may be used to indicate the complexity for the matching neighborhoods or blocks. One method is the Activity measurement method, which is the sum of the absolute difference of consecutive elements in a row added to the sum of absolute difference of consecutive elements in a column within the searching area or block. Another method is the Mean Absolute Difference (MAD) method, which is applied to a sample square-shaped searching area or block of size of

$$N \times N : MAD = \frac{1}{{N}^{2}} {\sum }_{j = 0}^{N - 1} {\sum }_{i = 0}^{N - 1} \vert {Y}_{i , j} - \overline{Y} \vert where \overline{Y} = \frac{1}{{N}^{2}} {\sum }_{j = 0}^{N - 1} {\sum }_{i = 0}^{N - 1} {Y}_{i , j} ;$$

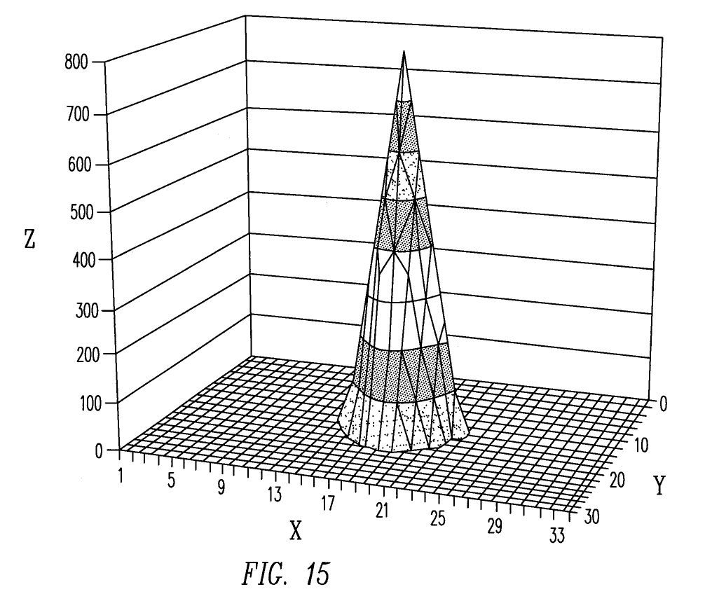

and Yᵢⱼ is the luminance of the pixel at the i^{th} row and the j^{th} column. FIG. 15 is an example of a 3-dimensional histogram of movement vector occurrences (weighted by activity).

In a capsule camera application, in order to avoid having areas not photographed (thereby, increasing the detection rate of anomaly conditions in the digestive tract), images are separated over a very small time interval. Therefore, two consecutive images may include substantial amounts of overlap. By finding a movement vector for consecutive images, or for images taken at different time points, the overlapping image areas can be identified and eliminated from one of the images.

If 50,000 images or more are taken in the small intestine, for example, and assuming the small intestine is 5.6 M (approximately the actual length of a normal adult), each image on the average provides a 0.1 mm strip of new area. Each image typically covers a significantly greater length than this strip. By eliminating overlap and by using a movement vector, the actual compression ratio is greatly increased. This method can be combined with previously discussed compression techniques, especially the MPEG-like compression technique, where the motion estimation capability may be shared, and motion vectors derived in the compression process could be leveraged for use to eliminate overlap.

Of course, the reference frame need also be associated with motion vectors in other frames encoded relative to the reference frame. In conjunction with the previous embodiment using I and P frames, where only an I frames may be used as a reference frame, the entire I frame may be needed. However, since such a group may include 10 images or more, the compression ratio is still greatly enhanced.

Or if JEPG-like intra compression algorithm is used, the overlapped portion could be removed from storage or not transmitted.

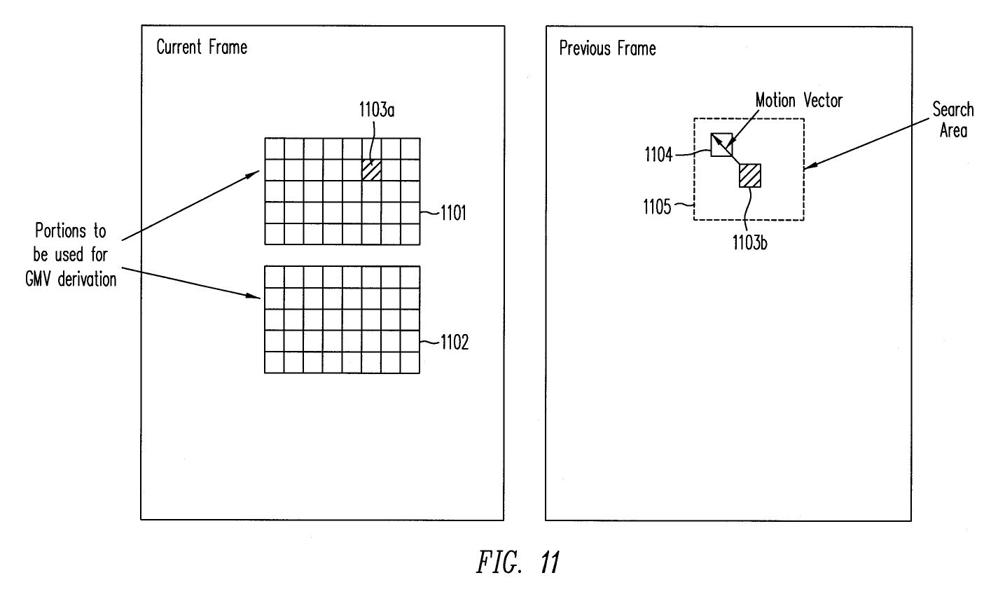

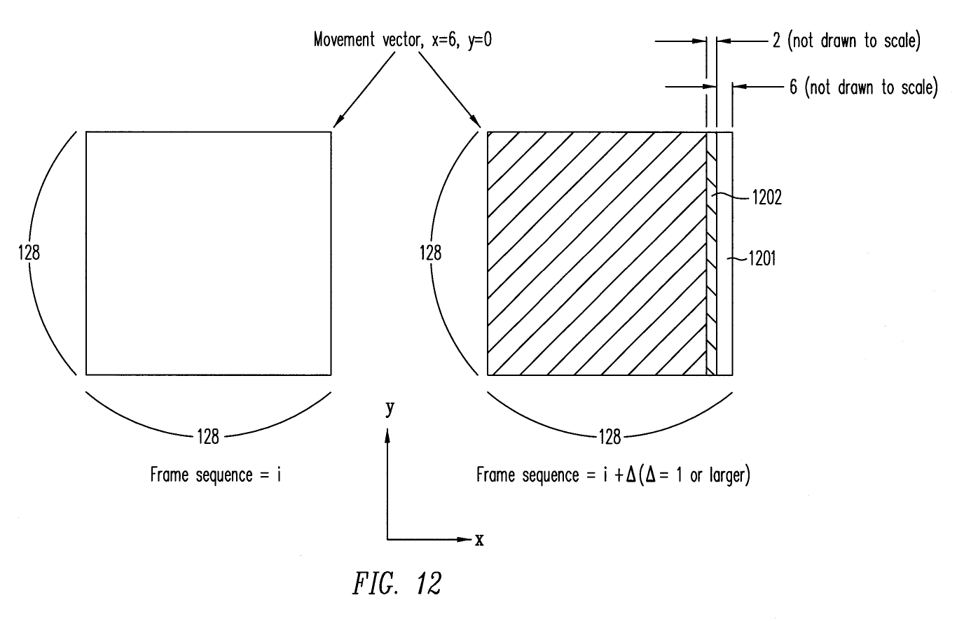

The end result is an effective compression ratio much higher than that already achieved by MPEG or JPEG. It also saves power, as overlap areas to be eliminated from the image need not be compressed. FIG. 12 shows one method of eliminating the overlap. As shown in FIG. 12, relative to frame i, frame i+Δ represents an image after the capsule advanced by 6 units in the +x direction. Strip 1201 (having a width of 6 units in the x direction) represents new information in frame i+Δ, relative to frame i. The remainder of frame i+Δ overlaps the image of frame i and thus may be eliminated. To avoid errors in deriving the movement vector, strip 1202 (having a width of 2 units in the x direction) is retained. (Of course, the 2 unit overlap retained is merely exemplary, any reasonable length may also be retained). The combined areas of strips 1201 and 1202 are compressed. In many image processing algorithms, pixels are often grouped in 8's or 16's. (For example, a DCT is often performed using an 8×8 pixel block). The width of the overlap to retain may be selected, for example, such that the resulting image may be conveniently handled by one of these algorithms.

The distance covered by consecutive images may be accumulated to provide critical location information for doctors to determine the location where a potential problem has been found. A time stamp could be stored with each image, or every few images, or on images meeting some criteria. The process of finding the best match may be complicated by the different exposure times, illumination intensity and camera gain at the times the images were taken, these parameters may be used to compensate pixel values before conducting the movement search. The pixels' values are linearly proportional to each of these individual values. If the image data are stored on board or transmitted outside the body and the motion search or other operation will be done later outside the body then these parameter values are stored or transmitted together with the associated image to facilitate easier but more accurate calculations.

The compression takes advantage of the fact that the movement is almost entirely in the x dimension, and almost entirely in the positive x direction. Overlapping portions of each image are eliminated, drastically reducing the amount of data to be stored or transmitted.

Given a reference image I₀(p) sampled at pixel location pᵢ=(xᵢ, yᵢ), it is desired to locate the vector that provides the current image I₁(p). Such a vector may be found, for example, by minimizing the cost function E given by

$$E = {\sum }_{i} {I}_{1} ( {p}_{i} + u ) - {I}_{0} ( {p}_{i} )$$

where u=(u, v) is the movement or displacement vector. The minima of the cost function may be found, for example, by the Newton-Raphson method. In general, the displacement could be fractional, and I₀ or I₁ could be suitably interpolated before the operation.

An improvement to searching using SAD, or any method that measure the overall pixel differences for the current block and the candidate matching block, takes advantage of the fact that subsequent steps in image processing are such frequency domain operations as DCT, quantization and entropy coding. Consider a candidate block that differs from the current block by a value of 20 at each pixel. In such a candidate block, while the SAD may appear to be large, every element in the difference block has a value of 20. Such a difference block has “energy” at very low frequency. As a result, compression can be very efficiently performed in an MPEG-like compression algorithm based on frequency domain entropy coding. The large SAD, however, may cause this candidate block not to be selected. Therefore, for high compression efficiency, rather than identifying a reference block using a minimum matching error criterion (e.g., using such criteria as SAD or SSD), the desirable reference block selection criterion should be based on variations in the difference block. For example, one way to improve frequency domain performance is to compute an average of the difference block and take the SAD between each element of the candidate block and this computed average. Such a quantity measures an “activity” of the block relative to common base line. This activity can then be used to determine the best match. Alternatively, the activity and the SAD, or a similar metric, may be used jointly to select the best match candidate block. Other measures of activity may also be used.

In MPEG encoding, significant computational power is allocated to best match candidate block searches and related data accesses, especially pixel data access methods and data path design efforts. A measurement step for estimating the frequency content of the difference block adds relatively small burden to the total effort by comparison. However, to improve MPEG performance, the conventional MPEG approaches require significant effort in hardware design. In fact, in some instances, the efforts may even lead to lower compression ratio. Therefore, according to one embodiment of the present invention, instead of minimizing the cost function for the best pixel value matching between corresponding pixel values in a current block and a candidate reference block, a different function may be provided in place of computing the SAD or the sum of squares of difference (SSD), given respectively by:

SAD=Σ_{i,j}|Cᵢⱼ−R_{i,j}|

SSD=Σ_{i,j}(Cᵢⱼ−Rᵢᵢⱼ)²

where Cᵢⱼ and Rᵢⱼ are the corresponding elements in the candidate block and the reference block, respectively. Both functions provide a measure of dissimilarity between the candidate reference block and the current block. A function which depends on both the SAD and the activity may be formed, for example, by:

$$F ( SAD , ACT ) SAD * ACT = ( {\sum }_{i , j} \vert {C}_{ij} - {R}_{ij} \vert ) ( {\sum }_{i , j} \vert {d}_{ij} - \overline{d} \vert )$$

where dᵢⱼ=Cᵢⱼ−Rᵢⱼ and

$$\overline{d} = {\sum }_{i , j} {d}_{ij} .$$

### ACT includes a Statistical parameter—in this case, an average—that provides a selected characteristic of the difference block.

Alternatively, in another embodiment, the median of the elements in the difference block is used as the statistical parameter in the above equation, in place of the average d̅. In another embodiment, the average d̅ is calculated using only a subset of the elements of the difference block (e.g., every other element in a row or every other element in a column) to reduce the processing power requirement. In another embodiment, the values | d̅−dᵢⱼ| are obtained for a subset of elements dᵢⱼ. Only these values are then summed to obtain an activity value. For example, a 16×16 block may be divided into 16 4×4 block, and one element is selected from each 4×4 block to calculate the activity for the 16×16 block. In another embodiment, filtering may be applied before a simplified operation is carried out or a mathematical manipulation over the elements of the difference block. For example, a subset of elements of a difference block may be summed and averaged before calculating an estimation of the difference between that average and the average over all elements.

In another embodiment, activity may be defined as the sum of the absolute differences of consecutive elements in rows (Aᵣ) and the absolute differences of consecutive elements in columns of the block: ACT=Aᵣ+A_{c}, where

$${A}_{r} = {\sum }_{i = 0}^{N - 1} {\sum }_{j = 0}^{N - 2} \vert {d}_{i ( j + 1 )} - {d}_{ij} \vert ,$$

$${A}_{c} = {\sum }_{i = 0}^{N - 2} {\sum }_{j = 0}^{N - 1} \vert {d}_{( j + 1 ) j} - {d}_{ij} \vert ,$$

and dᵢⱼ is the (i, j)-element in a N×N difference block. In another embodiment, only a subset of the elements in a difference block is used to calculate an activity. For example, in one embodiment, Aᵣ is calculated using only every other element in a row (i.e., only one-half of the elements are used). In another embodiment, filtering may be applied before using a simplified operation or a mathematical manipulation over the elements of the difference block. For example, elements may be grouped and summed before the estimating a difference between groups.

Other activity-related functions are possible. For example, one function which depends on both SAD and ACT is:

F(SAD,ACT)=pₛ*SAD+pₐ*ACT

where weights pₛ and pₐ may be empirically determined. Thus, the methods of the present invention optimize coding for motion estimation in both the space domain and the frequency domain operations that typically follow motion estimation in MPEG-like compression algorithms. In one embodiment, either pₛ or p_{d} may be set to 1 to provide a simpler function. For example, F(SAD, ACT)=SAD+pₐ*ACT. Another example is F(SAD, ACT)=(SAD^{P})*(ACT^{Q}), where P and Q are appropriate powers (i.e., this is the general case of F(SAD, ACT)=SAD*ACT). Yet another example is F(SAD, ACT)=p₁*SAD^{P}+p₂*ACT^{Q}, where p₁ is a function of ACT, and p₂, P and Q are other appropriate values, such as those provided in the examples above. For example, p₁ is assigned a first value, if the activity function is between 0 and a first predetermined value T₁ (i.e., 0≦ACT≦T₁), p₁ is assigned a second value, if the activity function is between the first predetermined value T₁ and a second predetermined value T₂ (i.e., T₁≦ACT≦T₂), and p₁ is assigned a third value, if the activity function is between the second predetermined value T₂ and a third predetermined value T₃ (i.e., T₂≦ACT≦T₃), and so forth. Alternatively, p₁ may a continuous function of the activity function ACT. Other functions of ACT and SAD may also be used. Calculations of the F, SAD, ACT and other functions may be implemented by analog circuit.

Note that, while some of the examples of an activity function provided in this detailed description to illustrate the concept of activity also depend upon SAD, an activity function need not involve SAD. In another implementation, each of the above discussed activity-related functions, the SAD may be substituted by SSD. Even though, in the examples above, the activity is a function of the values of the elements of a difference block, activity may also be defined by a function of the squares of the elements of the difference block. For example, one may substitute dᵢⱼ in any activity ACT above by sdᵢⱼ defined as, for example, sdᵢⱼ=dᵢⱼ*dᵢⱼ, or by any other monotonically increasing function of dᵢⱼ.

The present invention is also applicable to a candidate block that is defined by reference to one or more other blocks (e.g., a bidirectional or “B” frame defined by reference to both forward and backward predictive blocks or frames). Such a candidate block may be derived directly from one or more predictive frames, or may be formed by mathematically combining blocks that are derived from the predictive frames. The activity function may be used to select the best candidate block from among all candidate blocks. Further, the value of the activity function calculated over the current block to be compressed may be compared with the value of the activity function calculated over a difference block formed by the current block and the candidate block. Based on which of the two values of the activity function is smaller, either the current block or the difference block is compressed. When comparing the values of an activity function, certain types of compression algorithms or candidate blocks may be given a more favorable weighting. For example, to save power, one option is to compress the current block by itself using an “intraframe” coding scheme. Such an option may be given a more favorable weighting, as it requires less operations to decompress (hence lower power). Similarly, lower power is also achieved giving more favorable weight to a candidate block obtained directly from predictive frames than a candidate block obtained from blocks derived from the predictive frames.

In another embodiment, more than one reference blocks may be selected for each current block during the reference block searching process. For non-real time or off-line encoding, the encoder may test encoding the current block using any of the different reference blocks and select the reference block which achieves the highest compression ratio (i.e., which results in the least number of bits after compression). For real time applications, however, because of the computational intensity and the power requirements in the searching processes, MPEG-like compression algorithms are most prevalent. Other processes may be implemented when extra processing capacity is available. For example, if each process can be implemented at twice real-time rate, two best reference blocks may be processed to allow selecting the better reference block based on the actual compression achieved. In yet another embodiment, the number of selected reference blocks may be varied based on the processing capacity and the number of selected reference blocks in the pipeline to be processed, as one current block may have more reference candidates than other current blocks (e.g. when one reference block candidate is clearly better than the other reference block candidates, or when no good candidate block is found).

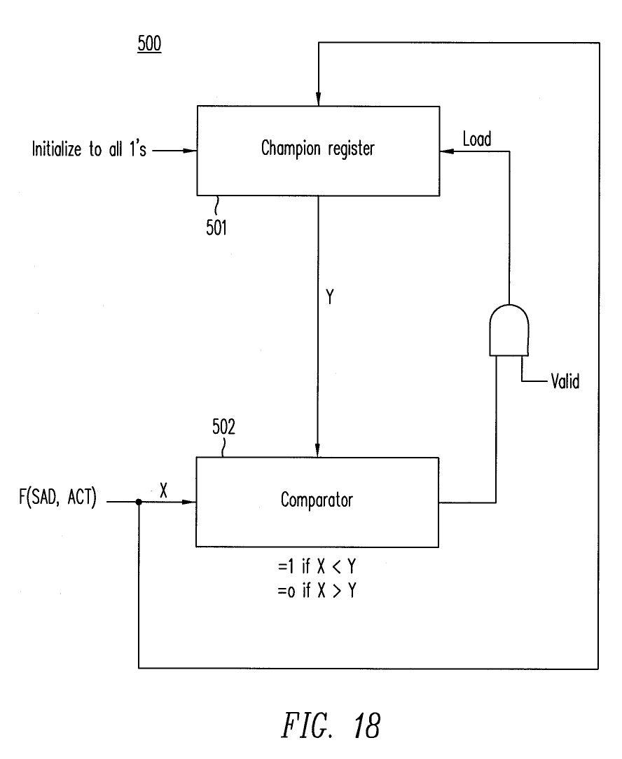

FIG. 18 is a block diagram showing a design of best match selector 500, according to one embodiment of the present invention. As shown in FIG. 18, “champion” register 502 contains an identifier (e.g., an memory address) identifying the current champion reference block (i.e., the candidate reference block which has the least F(SAD, ACT) among all candidate reference block of the reference frame examined at any given time within a search). At the beginning of each search, champion register 501 contains a dummy identifier value which is ‘1’ at every bit position and a dummy F(SAD, ACT) value which is larger than any allowable F(SAD, ACT) value. Each candidate reference block within the search range is then examined by computing the F(SAD, ACT) between the candidate reference block and the current block. Using comparator 501, the F(SAD, ACT) associated with the currently examined candidate reference block is compared to the F(SAD, ACT) value stored in champion register 502. If the F(SAD, ACT) value associated with the currently examined reference block is less than the F(SAD, ACT) value in champion register 502, the identifier associated with the current candidate reference block replaces the identifier in champion register 502. The match selector is enabled through the valid signal coming from different part of the MPEG encoder SOC.

Match selector 500 may save one or more sets of metrics (e.g., one or more SADs and ACTs), and may use one or more functions that can serve as F(SAD, ACT)). At the end of the search for each current block, the saved sets of SAD and ACT values may be used to compute the F(SAD, ACT) values. Such a scheme provides the advantage that a complicated F(SAD, ACT) may be used without having to compute F(SAD, ACT) for each block, which may be prohibitively computationally intensive, if calculated for every candidate reference block.

Although the major direction in the GI tract is from mouth to anus, there will be movement along y direction and the capsule will rotate and focus on objects in the field of view with varying distance. For a more general movement (i.e., instead of simple translation), the cost function is given by

$$E = {\sum }_{i} {I}_{1} ( f ( {p}_{i} ; {m}_{0} ) ) - {I}_{0} ( {p}_{i} ) ,$$

where m₀ is a multi-dimensional vector having general parameters describing the motion, including possibly multiple rotational angles. In one embodiment, m₀ is a function of three positional coordinates, three angles and a focal distance (i.e., m₀(x, y, z, θₐ, θ_{b}, θ_{c}, d)). The minima of the cost function may be found, for example, by operations on Jacobian matrices. By optimizing the parametric values of function ƒ for the minimum E, the corresponding relationship between I₁ and I₀ and overlapped region can be found.

Alternatively, to reduce the calculation, a subset of interesting points (e.g., features like local minima and maxima in both images and corresponding small neighborhood around them) may be used to find the optimal correspondence and alignment rather than using all pixels in the images.

Parametric values could be transmitted along with the remaining images which are ready to be stitched into the whole image for the actual reality display. These parameters containing the camera pose parameters, or how an image pair is related to each other can later be exploited to facilitate user friendly presentation to doctors. For example, a camera position, specified uniquely by pose parameters, could be chosen according to the desired point of view (e.g., the convenient viewing angle and distance). Using pose parameter sets of the corresponding original images, and the mapping or transformation of the non-overlapping image portions according to the desired pose parameters, the non-overlapping image portions could be stitched together according to the desired point of view.

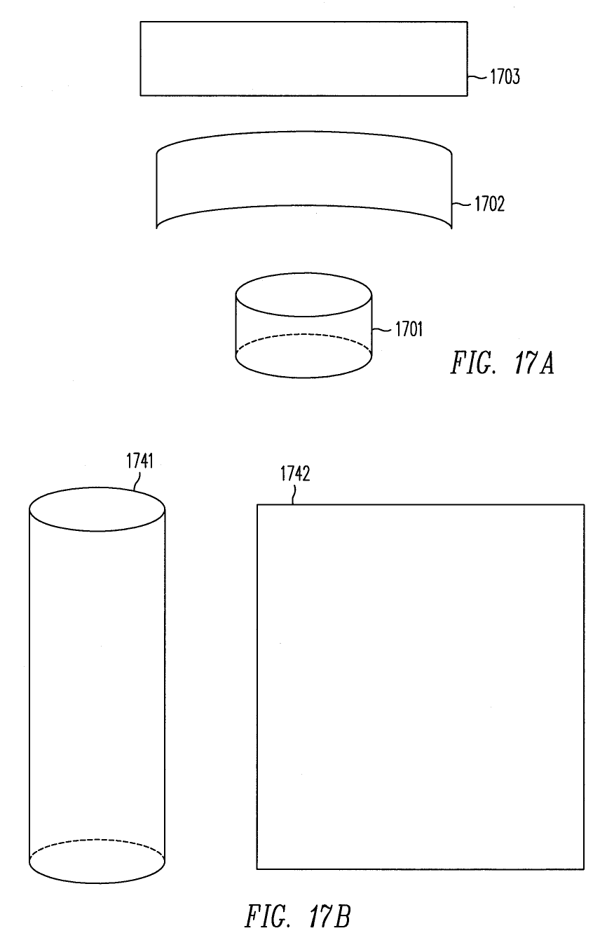

Using the methods described above, the panoramic view frames may be stitched together to provide an “actual reality” image of the inner wall of a section of the GI tract. FIG. 17A shows ring-shape section 1701, which represents a short section of the GI tract. To facilitate viewing, ring-shape section 1701 can be opened up to provide the curved section 1702. Curved section 1702 can be further stretched to provide rectangular section 1703. As the panoramic views are stitched together to form a longer section of the GI tract, the resulting image is a tubular (cylindrical, or “snake skin” shape) “actual reality” image 1741, shown in FIG. 17B. To facilitate viewing, image 1741 can also be opened up and displayed as rectangular image 1742 of FIG. 17B using the transformation (i.e., opening up and stretching) shown in FIG. 17A.

The detailed description above is provided to illustrate the specific embodiments of the present invention and is not intended to be limiting. Numerous modifications and variations within the scope of the present invention are possible. The present invention is set forth in the following claims.

I claim:

1. A method for data compression of image, comprising:
representing the image into a plurality of blocks;
selecting a block according to a predetermined sequence; and
processing each selected block by:
identifying a reference block from a plurality of previously processed blocks in the image using an activity function; and
using the reference block, compressing the selected block.

2. A method as in claim 1, wherein compressing the selected block comprises compressing a difference block which elements are the element-by-element differences between the selected block and the reference block.

3. A method as in claim 2, wherein the activity function is applied to elements of the difference block.

4. A method as in claim 3, wherein the activity function depends on a statistical parameter over the elements of the difference block.

5. A method as in claim 4, wherein the activity function depends further on an absolute difference between elements of the difference block and the statistical parameter.

6. A method as in claim 3, wherein the activity function depends on the differences among elements in the difference block.

7. A method as in claim 3, wherein the activity function depends on the differences among values obtained from a monotonically increasing function of one or more elements of the difference block.

8. A method as in claim 6, wherein the activity function depends on (a) differences between elements in adjacent rows of the difference block; and (b) differences between elements in adjacent columns of the difference block.

9. A method as in claim 2, wherein the reference block is identified by minimizing a cost function that depends on the activity function and a dissimilarity function which depends on differences between corresponding elements in the reference block and the selected block.

10. A method as in claim 9, wherein the dissimilarity function is one of: a sum of absolute differences function and a sum of square differences function.

11. A method as in claim 9, wherein the cost function is a weighted sum of the activity function and the dissimilarity function.

12. A method as in claim 2, wherein the predetermined sequence traverses the blocks in increasing row direction and, within each row, in increasing column direction.

13. A method as in claim 1, wherein the compressing comprises performing a discrete cosine transform followed by quantization.

14. A method as in claim 1, wherein the previously processed blocks are within a predetermined distance from the selected block.

15. A method as in claim 1 wherein the selected block is a block defined relative to one or more predictive blocks.

16. A method as in claim 15, wherein the selected block is selected from a plurality of candidate blocks for compression, each candidate block being assigned a weight based on resource requirements for compression or decompression.

17. A method for reducing memory requirement in performing an interframe image compression, comprising:
performing an intraframe data compression of a first frame, the intraframe compression comprises:
dividing the image of the first frame into a plurality of blocks;
selecting a block according to a predetermined sequence; and
processing each selected block by:
identifying a reference block from a plurality of previously processed blocks in the image using an activity function; and
using the reference block, compressing the selected block;
storing the intraframe compressed first frame in a frame buffer;
receiving a second frame;
detecting matching blocks in the first frame and the second frame by comparing blocks in a second frame to decompressed blocks in a selected portions of the first frame; and
compressing the second frame according the matching blocks detected.

18. A method as in claim 17 wherein the decompressed blocks are decompressed concurrently with receiving the second frame.

19. A method as in claim 17 wherein the blocks in the first and second frames are each arranged in an array, and wherein the detecting comprising taking each block in the second frame in a predetermined order and, for each block selected, performing:
providing in a buffer memory decompressed blocks in the first frame corresponding to a search area including a block in the first frame corresponding in position to the selected block; and
matching the selected block to the decompressed blocks in the buffer memory.

20. A method as in claim 19, wherein the predetermined order is row by row.

21. A method as in claim 20, wherein within each row, the predetermined order proceeds from block to adjacent block.

22. A method as in claim 19, wherein the search areas of two successively selected blocks taken overlap, and wherein the decompressed blocks of the search area corresponding to the subsequent one of the two successively selected blocks are allocated space in the buffer memory occupied by decompressed blocks of the search area corresponding to the previous one of the two successively selected blocks.

23. A method as in claim 22, wherein the non-overlapping blocks of the search area corresponding to the subsequent selected block is decompressed when the subsequent selected block is taken.

24. A method as in claim 17, wherein the second frame is compressed as a residual frame derived from the first frame and the second frame.

25. A method as in claim 17, wherein compressing the selected block comprises compressing a difference between the selected block and the reference block.

26. A method as in claim 17, wherein the activity function depends on a statistical parameter of the elements of the difference block.

27. A method as in claim 26, wherein the activity function depends on a statistical parameter of the elements of the difference block.

28. A method as in claim 27, wherein the activity function depends further on an absolute difference between elements of the difference block and the statistical parameter.

29. A method as in claim 26, wherein the activity function depends on the differences among elements in the difference block.

30. A method as in claim 29, wherein the activity function depends on (a) differences between elements in adjacent rows of the difference block; and (b) differences between elements in adjacent columns of the difference block.

31. A method as in claim 25, wherein the reference block is identified by minimizing a cost function that depends on the activity function and a dissimilarity function which depends on differences between corresponding elements in the reference block and the selected block.

32. A method as in claim 31, wherein the dissimilarity function is one of: a sum of absolute differences function and a sum of square differences function.

33. A method as in claim 31, wherein the cost function is a weighted sum of the activity function and the dissimilarity function.

34. A method as in claim 23, wherein the predetermined sequence traverses the blocks in increasing row direction and, within each row, in increasing column direction.

35. A method as in claim 23, wherein the compressing comprises performing a discrete cosine transform followed by quantization.

36. A method as in claim 23, wherein the previously processed blocks are within a predetermined distance from the selected block.

37. A method as in claim 17 wherein the selected block is a block defined relative to one or more predictive blocks.

38. A method as in claim 38, wherein the selected block is selected from a plurality of candidate blocks for compression, each candidate block being assigned a weight based on resource requirements for compression or decompression.

39. A circuit for identification of a reference frame for video compression of a current image frame, comprising:
a champion register for holding a current parameter value, the champion register receiving a load signal and an input value which becomes the current parameter value when the load signal is asserted;
a comparator receiving activity metric and the current parameter value for providing the activity metric and a result value indicative of whether the activity metric is less than the current parameter value; and
a logic circuit which generates the load signal and provides the activity metric as the input value to the champion register in accordance with the result value.

40. A circuit as in claim 39, wherein the activity metric depends on an average of the elements of a difference block, the difference block being a block which elements are each a difference between an element of the current image frame and a corresponding element of the reference frame.

41. A circuit as in claim 40, wherein the activity metric depends on elements of a difference block, the difference block being a block which elements are each a difference between an element of the current image frame and a corresponding element of the reference frame, and wherein the activity metric is a function of (a) differences between two successive consecutive elements of each row of the difference block; and (b) differences between two consecutive elements of each column of the difference block.

42. A circuit as in claim 40, wherein the reference block is identified by minimizing a cost function based on the activity metric and a function representative of a dissimilarity between the reference block and the selected block.

43. A circuit as in claim 40, wherein the cost function is a weighted sum of the activity metric and a function representative of a dissimilarity between the reference block and the selected block.

44. A circuit as in claim 42, wherein the function representative of a dissimilarity comprises either a sum of absolute differences function or a sum of square differences function.
